(19) United States
(12) Patent Application Publication
(10) Pub. No.: US 2006/0139175 A1
(43) Pub. Date: Jun. 29, 2006

(54) Object identifying method and apparatus

(75) Inventor: John P Cosier, Caterham (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/540,595

(22) PCT Filed: Dec. 11, 2003
(86) PCT No.: PCT/IB03/05941

§ 371 Date: Jun. 23, 2005

(30) Foreign Application Priority Data
Dec. 27, 2002 (GB) 02303600

(51) Int. Cl. G08B 13/14; H04Q 5/22; G06Q 30/00

(52) U.S. Cl. 340/572.8; 235/385; 340/10.51

(57) ABSTRACT

A finger worn device (10) includes a tag reader for reading tags (12a, 12b) attached to similar shaped items (11a, 11b) respectively, an example of such items being jars containing different foodstuffs. When the device (10) is presented to one of the tags (12a, 12b) the device (10) reads data from the tag generates an output signal such as a tactile or audio output. The output signal is dependent on the tag being read. The user of the device has knowledge of a pre-defined association between a particular tag and a particular output signal that the device will produce on reading that tag. Furthermore the user has knowledge of which tag is provided on which item. Therefore, the user is able to establish which item is being presented to the device (10) by noting the output signal produced. The device is intended to assist a person who is blind or has poor eyesight with the task of identifying articles which are similarly shaped. The tags may be programmed with data describing the article, such as a text string, thereby permitting the data to be processed by a text-to-speech converter on the device (10) to produce synthesised speech describing the article.

The present invention relates to a method and apparatus for assisting in the identification of articles, which are particularly, but not exclusively, useful for identifying articles in circumstances where visual identification is impeded.

There are a number of occasions when it is necessary to identify a particular article in circumstances where visual identification is either impossible, difficult or otherwise unsatisfactory. This is particularly the case where tactile interaction with an article does not readily convey sufficient information for an article to be identified by feel.

In a first example where the above difficulties apply, consider the position of a visually impaired or blind person attempting to distinguish between boxes of cereal located in a kitchen cupboard, or attempting to choose a particular flavour of jam from a number of jam jars. Difficulties arise because the tactile feel of the containers does not convey (either readily or at all), specific details of the containers contents. It is sometimes possible to establish contents of a container in other ways, by using other senses such as smell or taste, but this is not always possible. Indeed employing the use of other appropriate senses is not always appropriate if the containers hold potentially harmful chemicals. In any case, even if a visually impaired person has come to the decision regarding the identity of an article, confirmation that the correct decision has been made is still useful in many cases.

Similar difficulties in identifying an article can occur where a sighted person does not wish to divert the focus of their sight away from a task in progress, which leads to problems in finding or identifying an article, such as a particular required tool, needed during the course of performing the task. An example of this is that of a car mechanic concentrating on the work area while groping for a spanner.

It is an object of the present invention to provide a method or apparatus which serves to obviate or reduce the above mentioned problems.

In accordance with a first aspect of the present invention there is provided a method of assisting in identifying an article, said method comprising the steps of:

presenting to a wearable tag reader a tag associated with an article:

communicating information held in said tag to the tag reader: and

generating an output signal that is dependent on the information communicated from the tag to the tag reader, wherein said output signal facilitates identification of the article with which the tag is associated by virtue of said association being user definable and established prior to said step of communicating.

A tag reader is able to read nearby tags when the user presents the reader to a tag.

Preferably the reader is in the form of a device worn on the hand or finger such as a ring. In this case where a user approaches a tagged article with the reader, or feels or picks up a tagged article, the tag will be read by the tag reader and an output is produced. The reader may be in the form of another item such as a thimble or bracelet.

Ideally the reader may be worn by a person for extended periods in which case is it particularly preferable that the reader is as unobtrusive as possible. By wearing the reader for extended periods, the method of the present invention is more likely to be readily available to a user thereby enhancing the enjoyment of the benefits.

The generated output signal can take various forms but may be in the form of an audible or tactile output. For example, a tactile output may consist of a pulsing vibrating alert occurring a set number of times depending on the information derived from the tag. If the user knows a certain number of pulses correspond to a particular variety of jam for example, the jam can be differentiated from other identical or similarly shaped containers holding different contents by providing those other containers with tags which cause the device to produce a different output when the tags are read, or by not providing those other containers with tags at all, in which case there will be no output signal generated.

Similarly, if a user knows a certain number of pulses correspond to a particular variety of cereal, the cereal can be differentiated from other identical or similarly shaped containers holding different contents by providing those other containers with tags which cause the production of a different output when those tags are read. Differentiation from tagged boxes of cereal may be achieved by not providing a particular box with a tag in which case the untagged container will not result in the generation of an output signal.

Other forms of output signal include a repeated output pattern, particular frequency of even a coded signal such as Morse code.

Since the container for jam is typically a jar and the container for cereal is typically a box, a user is unlikely to confuse the two containers. Therefore, it is permissible to use tags that when read by a tag reader cause the same output signal to be generated providing that the tags are associated with items which can be differentiated from each other in other ways, such as by the shape of the container. Therefore, if two tags are employed which cause generation of the same output signal when read, for example two output pulses, providing those two tags are fitted to dissimilarly shaped items such as a jar of jam and cereal box, a user is not confused.

In one example application of the present invention, a blind person requests a friend or assistant to apply tags to items. The person applying the tags tells the blind person which tag is associated with which article or object. This means that the blind person is also able to know which generated output signal can be expected on occurrence of reading that tag. Alternatively, the blind person is able to direct which tags are associated with a particular article or object, such that the association is to their preference which can assist in remembering the chosen association.

Optionally, substantially identical tags resulting in generation of the same output signal when read can be provided for applying to more than one article where the article can be distinguished from other articles, say by differing shape. This allows a relatively small set, for example 5 to 30 different tag types to be provided, rather than requiring all tags to be unique in terms of the information they carry. This arrangement has the potential to provide a low cost implementation of the present invention. Furthermore, the existence of readily available substantially similar or identical tags allows a fresh tag of the same/similar type as an old tag to be added to a new box of cereal when the previous box (carrying the old tag) of the same type of cereal is exhausted. This approach provides continuity in a particular association between commodity and tag, thereby assisting a person in memorising the association.

In principle, more than one tag can be associated with the same article providing the reader can read multiple tags and produce a suitable output; this way use of two or more tags can results in generation of a compound output signal permitting a greater number of output signals to be generated than there are different types of tags.

There may be provided the option for defining the particular output signal produced on the occurrence of reading particular information from a tag. In this manner a user may control the output signal produced when a given tag is read. The resulting output signal for the occurrence of reading particular information from a tag may be governed by use of a look-up table or the like.

The above described arrangements rely on a user knowing in advance the association between an item and a particular predefined output signal which is actually dependent on the tag identity. However, in another arrangement tags may be programmable allowing a user to have some control over the information the tags send to the reader and thereby affect the generated output signal. Indeed, tags may be programmable to hold information that describes in some manner the article the tag is associated with. For example, in the case of a tag that is affixed to a jar of strawberry jam, the tag could be programmed with data that represents the message ‘STRAWBERRY JAM’. The data could be in the form of an alpha-numerical text string “STRAWBERRY JAM” and such information would be communicated to a tag reader during a reading process of that tag. This information may then be conveyed to a user by suitable means, two examples of which are a tactile brail reproduction device or a text-to-speech converter.

Tags may be associated with an article during manufacture of the article. It will sometimes be necessary for a user to be informed of the association between the output signal that is generated on reading the tag.

These and other aspects of the present invention appear in the appended claims to which the reader is now referred and which are incorporated herein by reference.

The present invention will now be described with reference to the figures of the accompanying drawings in which:

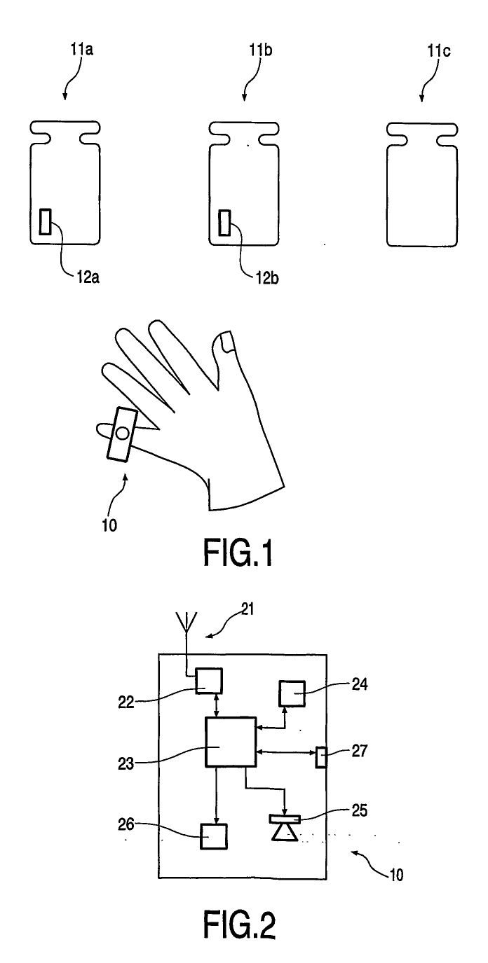

FIG. 1 shows an embodiment of apparatus including a tag reading device for performing the present invention; and

FIG. 2 shows a schematic representation of components of the tag reading device.

It should be noted that the drawings are diagrammatic and not drawn to scale. Relative dimensions and proportions of parts of the Figures have been shown exaggerated or reduced in size for the sake of clarity and convenience in the drawings. The same reference signs are generally used to refer to corresponding or similar features in the different embodiments.

The first embodiment includes a finger worn device 10 comprising an antenna 21, radio frequency (RF) transceiver 22 connected to the antenna, microprocessor 23, memory 24, output speaker 25 and vibrator 26. The device also includes an I/O interface 27 which may take the form of an electrical connector, infrared connector or some other wireless link facility. The I/O interface connects to a personal computer, personal digital assistant (PDA) or the like for programming or interrogation purposes. The transceiver 22, memory 24, speaker 25, vibrator 26 and I/O interface 27 are all in communication with and controllable by the microprocessor 23. The components 21 to 27 of the device are shown to illustrate the basic building blocks of the device 10 but without limitation to the present invention. The microprocessor is configured to perform tasks and interact with the other components to bring about the required operation of the device 10 including the required interaction with tags. The device also has a power supply, typically in the form of a battery (not shown).

Specifically, one aspect of such operation is the reading of tags which is possible through the interaction of the microprocessor 23 carrying out instructions and the transceiver 22 to cause reception {and possibly emission) of magnetic, electrical or electromagnetic radiation by the antenna 21. Such operation of these components thus forms means for providing a tag reader. In a similar manner, interaction of the microprocessor carrying out instructions and the speaker 25 and/or vibrator 26 form means for providing output signal generating means.

The device 10 is housed in a finger mountable enclosure such that it may be worn in the same fashion as a ring.

Jars 11a, 11b, 11c containing different foodstuffs, in this case preserves of different flavours of jam and marmalade are now considered. For illustrative purposes only, jar 11a contains strawberry jam, 11b contains raspberry jam and 11c contains marmalade. The exterior form of the jars is the same or very similar so differentiating between the jars by feel alone is impossible or difficult. However, first jar 11a is provided with first tag 12a, second jar 11b is provided with second tag 12b and third jar 11c is provided with no tag at all.

When a user approaches or picks up jar 11a, a tag 12a affixed to that jar is presented to device 10 causing an interaction between the device 10 and jar 11a resulting in information held by the tag 12a being read by the device 10. The particular tag 12a, affixed to jar 11a is known to cause an output from device 10 in the form of one pulse of vibration by activating the vibrating device 26. Since the vibrating device 26 is part of the finger worn device 10, a user feels the one pulse of vibration and is able to deduce that the jar in question is jar 11a containing strawberry jam, because the user remembers that the tag 12a of the type causing the reader to produce one pulse has previously been affixed to the jar of strawberry jam. That is, the user remembers the earlier defined association between the tagged item and consequential device output on occurrence of reading that tag.

Similarly, when a user approaches or picks up a jar 11b, the tag 12b affixed to that jar is presented to the device 10 causing an interaction between the device 10 and jar 11a resulting in information held by the tag 12b being read by the device 10. The particular tag 12b, affixed to jar 11b is known to cause an output from device 10 in the form of two pulses of vibration by activating the vibrating device 26. In a similar manner to the above mentioned process in respect of jar 11a, here a user is able to deduce that the jar in question is jar 11b containing raspberry jam. This is because the user remembers that tag 12b affixed to the jar 11b is of the type causing a reader to produce two pulses. That is the user remembers the association between the tagged item and consequential device output on occurrence of reading that tag.

Finally, jar 11c does not have a tag associated with it so the act of approaching this jar with the device 10 or picking up this jar 11c by hand while simultaneously wearing device 10 on that hand will not result in any device output. Thus, a user can deduce that the jar in question is not jar 11a or 11b, but some other jar instead. If a person knows he only owns three such jars, that person can deduce that when handling a jar which does not cause a new device output, it must be jar 11c.

Although 3 jars 11a, 11b and 11c have been discussed this is for illustrative purposes only and other numbers of jars or other such items may be envisaged without departing from the scope of the present invention.

In addition or instead of the device generating a tactile vibratory output, it may also generate other types of tactile output such as a tapping sensation on a user's hand or in the case of a finger worn device carry out a constricting action on the user's finger. Furthermore, other possible output signals include an audible output which may assume the form of a different number of pulses, different pitches or other varying output to distinguish between different tags being read.

A set of different tag types may be provided, for example ten different tag types each causing a reader to produce between one and ten pulses or otherwise one of ten different output types when that tag is read. Optionally, specific tag types corresponding to “danger” could be provided such that when the tag is read the device outputs a very distinct or accentuated type of output. Such tags could be affixed to containers of harmful substances such as bleach.

Optionally, a user is able to program or otherwise control the device 10 to produce a particular output signal depending on the tag that is read. This may be done, for example, by use of a look up table in the device, wherein the user is able to specify that in the event a tag is read having a particular identity, then a particular output should be generated. Programming the device 10 may be performed by connecting it via I/O interface 27 to a personal computer, personal digital assistant, mobile telecommunication apparatus or other suitable programming equipment. Alternatively, the device 10 may be programmed via antenna 21 and transceiver 22 or other wireless interface, including a radio frequency interface or infra red interface.

The first embodiment relies on the user or an assistant actively attaching a chosen tag to a particular article. A particular tag causes the device 10 to cause a particular output (subject to possible programming of the device 10) when the tag is read by the device. Therefore the user must remember the association between device output and the particular article that device output relates to. That is, the device output does not itself inherently convey information about the tagged article, rather it conveys information about which particular tag or tag type is being read.

In a second embodiment of the present invention, programmable tags are employed instead of tags 12a, 12b . . . 12n, allowing the user to program the tags to carry particular information. If a user wishes to tag a tin of baked beans, the user can program the tag with data such as a string of alpha numeric characters representing “BAKED BEANS”. Thus the tag carries data which actually describes a property of the article the tag is associated with. On reading this tag, the device extracts the text string “baked beans” and uses this as an input for a text-to-speech conversion process, carried out by microprocessor 23 performing suitable instructions, followed by the device generating an output in the form of synthesised speech reproducing the words “baked beans” emitted from the speaker 25. Thus in this arrangement there is no requirement to remember a set association between a particular article and resulting output signal in the form of a pulse sequence or the like. Furthermore, this arrangement allows a single type of programmable tag to be provided facilitating tagging of many articles merely by programming each tag with appropriate descriptive text or other information.

In the third embodiment of the present invention articles are provided with a tag at the article manufacturing stage thereby obviating the need for the tags to be attached by user. The tags may carry predefined identification data requiring a user to learn the association between the device output signal that results on reading data from that pre-attached tag. In addition, a user may configure the device 10 to generate a particular output signal on reading the pre-attached tag. Alternatively, where the pre-attached tag is programmable, the user may programme that tag with information to influence the resultant is output from device 10 on reading the tag. The information programmed into the tag may include information describing the article, similar to that described above with respect to the second embodiment. For example the user may programme the tags with an alpha-numeric text string.

Other uses and variations on the above mentioned embodiments are possible while still remaining within the scope of the present invention, as will be appreciated by the person skilled in the art. For example, when a person is working on a particular task such as a car repair job it is often difficult to locate a desired tool by feel alone, thereby requiring the person to look away from the item being worked upon. However, by tagging items in a tool box appropriately, the device of the present invention would allow a user to pick up a tool without looking and know which tool is being held by the characteristics of the generated output signal. This output could be in the form of coded signals or synthesised voice describing the tool. Items such as spanners may be tagged to determine the size of the spanner; for example when holding a spanner of 10 mm, 10 audible or tactile pulses could be produced by the device; alternatively the device could announce the size using a synthesised voice output. A similar approach could be used in the tagging of surgical implements.

Further applications involve the tagging of milk or other perishable foods to signify its delivery or expiry date, tagging of keys, tagging of nuts bolts and screws or other components (in these cases their boxes would be tagged), and the tagging of user controls of devices. Items such as fuses could be tagged for assistance in working in the dark should electrical lights go out. Pipes, valves, taps and cables could also be tagged for identification—in these cases the tags can replace normal identification signage to dissuade the casual user from interfering with these items articles because the casual user would be uncertain of the function of these devices without the appropriate device 10. In any case it is not mandatory that the article itself should be tagged directly. As an alternative tags could be positioned nearby the items to be identified for example by affixing a tag to a wall next to a tap rather than to the tap itself.

Suitable tag technology is dictated by the sophistication sought in a particular implementation. In the case where it is merely necessary to differentiate between a small number (2 to 10's of tags) low cost radio frequency (RFID) tags may be employed similar to those tags attached to articles in a retail outlet for security purposes. A more sophisticated implementation may be realised based on the Royal Philips Electronics so called “I.CODE” smart label technology. This is an RFID based technology designed to challenge ubiquitous bar code marking to serve mass markets with many millions of labels per application per year. These tags have a data retention period of 10 years, an operating range of 1.5 metres for detection, anticollision implementation, a 13.56 MHz operating frequency, an open communications protocol and they are programmable. The tags have a 512 bit read/write on-board memory including a 384 bit user memory, 64 bit unique serial number and a 64 bit system memory for configuration data. Although the tags have a quoted tag to reader operating range of 1.5 metres, the implementation described herein require a much shorter operating range thereby promising use of this technology in small battery powered wearable devices, such as device 10 where restricted power consumption and antenna size are design factors. Optionally, the device 10 may have a user activation/deactivation switch to conserve power. Other suitable tag technologies may be employed without departing from the present invention, as will be appreciated by the person skilled in the art.

Examples where articles may be tagged at the point of manufacture include postage stamps and bank notes to relay the value of the associated item to a user. In the case of stamps it may be preferable to tag the book of stamps rather than all stamps for reasons of economy. In the case of bank notes each note would need to be tagged. However, in the latter case there is not a requirement for a particular note to have a unique identity for establishing its value. Indeed, with the known practice of embedding metallic material in bank notes, a pattern of metallisation peculiar to the value of the bank note could be included, which pattern is detectable and distinguishable from patterns in other bank notes allowing the value of the note to be established by the reading device. Note, the present arrangement is concerned with the general identification of a banknote type to establish its value and is not concerned with the authentication or tracking of a particular bank note.

An extension to the above mentioned concept is the inclusion of supplemental information in the tags beyond mere identification data. In the case of food items the supplemental information could include the list of ingredients, and/or cooking instructions. In the case of other items basic usage instructions could be included. For example in the case of self assembly furniture, tagging a portion of one component could allow that component to be identified and further serve to provide instructions explaining how that component should be attached to a further component. Such an arrangement would also be of benefit to a sighted person because they would not be quite so reliant of an assembly instruction manual.

While the device has been described as housed in one unit, functional components of the device could be provided in a distributed arrangement. For example, only the tag reader component could be provided on the finger or in the vicinity of the hand while the remaining functional components are provided elsewhere, such as in a pocket. In this case a wired or wireless link could be provided between the components.

From reading the present disclosure other modifications will be apparent to persons skilled in the art. Such modifications may include other features which are already known in the design, manufacture and use of passive or active tags, readers for such tags, and coding, programming and applications thereof and which may be used instead of or in addition to features already described herein.

1. A method of assisting in identifying an article, said method comprising the steps of:
presenting to a wearable tag reader a tag associated with an article;
communicating information held in said tag to the tag reader; and
generating an output signal that is dependent on the information communicated from the tag to the tag reader, wherein said output signal facilities identification of the article with which the tag is associated by virtue of said association being user definable and established prior to said step of communicating.

2. A method in accordance with claim 1 wherein said wearable tag reader is wearable on a persons finger, hand, forearm, foot or other extremity of the body.

3. A method in accordance with claim 1 and further comprising the step of a user programming said tag prior to said step of communicating.

4. A method in accordance with claim 1, wherein said information held in the tag includes tag identity information.

5. A method in accordance with claim 1 wherein said information held in the tag includes data which describes a property of the article with which the tag is associated.

6. A method in accordance with claim 1 wherein said generated output signal is in the form of a tactile signal, audible signal, speech or other user decipherable information.

7. A method in accordance with claim 1 wherein said tag is a radio frequency identification (RFID) tag.

8. A method in accordance with claim 1 and further comprising the step of a user providing said tag.

9. An article provided with a tag, said tag being suitable for use in a method of assisting in identifying an article in accordance with claim 1.

10. A process comprising the step of affixing a tag to an article, said tag being suitable for use in a method of assisting in identifying an article in accordance with claim 1.

11. Apparatus for assisting in identifying an article, said apparatus comprising:
a wearable tag reader for reading information held in a tag associated with an article, the reading being performed when the wearable tag reader is presented to the tag, and
an output signal generating means coupled to said tag reader for generating an output signal dependent on the information communicated during reading from a tag presented to the reader, wherein said output signal facilitates identification of the article with which the tag is associated by virtue of said association being user definable and established prior to the tag reading.

12. A method, article provided with a tag or apparatus as described herein, with reference to or as illustrated in any one or more of the accompanying drawings.
